(19) United States
(12) Patent Application Publication
(10) Pub. No.: US 2003/0024360 A1
(43) Pub. Date: Feb. 6, 2003

(54) In-line rotary cutting and conveying system

(76) Inventor: Frederick W. Ribble, Jackson, TN (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/202,800

(22) Filed: Jul. 25, 2002

Related U.S. Application Data
(63) Continuation-in-part of application No. 09/921,441, filed on Aug. 2, 2001, now abandoned.

(51) Int. Cl. B26D 7/06

(52) U.S. Cl. 83/23

(57) ABSTRACT

An in-line cutting and conveying system for cutting and processing a plurality of individual product portions from a sheet of material has an anvil roll having an outer surface configured to receive and support a sheet of material. The system also has a cutter roll positioned adjacent to the anvil roll, and a plurality of spaced cutter cells to interface with the anvil roll in use. The cutter cells on the cutter roll each interface against the dough and anvil roll to separate and receive individual product portions of the material positioned on the outer surface of the anvil roll. A transfer roll is also positioned adjacent to the cutter roll to receive the individual product portions of material from the cutter roll. The system might also have a carrier system with a plurality of pockets to receive the individual portions of material from the transfer roll. The anvil roll might also have a cooling channel positioned to maintain the anvil roll's outer surface at a desired temperature and the plurality of cutter cells might be provided in the form of a plurality of interchangeable cutter blocks positioned on an outer surface of the cutter roll. The transfer can be indexed with a carrier to place individual product portions in designated carrier zones for further processing, such as frying dough portions.

### CROSS REFERENCE TO RELATED APPLICATION

This application is a continuation-in-part of prior application Ser. No. 09/921,441 filed on Aug. 2, 2001.

### FIELD OF THE INVENTION

The present invention relates to an improved in-line rotary cutting and conveying system, and more particularly, to an in-line rotary cutting and conveying system and method of using the same.

### BACKGROUND OF THE INVENTION

Systems that cut and convey materials have long been used in a variety of industries, such as the food processing industry. In particular, systems that provide basic food processing functions such as cutting, conveying and transferring of, for example, a dough or other food material to a fryer have been in existence for many years. Although there have been numerous designs of systems created to achieve these basic functions, some of the most desirable, have been rotary type systems.

Rotary systems provide numerous advantages over other types of systems, including, most importantly, the ability to maximize speed and throughput through a system. A typical rotary system such as a two-roll system or a three roll system might rely on a plurality of rollers to process, or to cut, convey and transfer, a sheet of material such as a dough sheet through the system. In particular, a two-roll system might comprise a cutter roll and an integral transfer/anvil roll in communication therewith and a three-roll system might comprise separate rolls: a cutter roll, a transfer roll and an anvil roll.

Typically, however, these prior art rotary systems suffer from a variety of negative limitations. For example, some two-roll systems have a transfer/anvil roll that provides a continuous cutting surface, positioned closely adjacent to a fryer to allow the cut dough portions to be transferred directly to the fryer. The continuous heat from the fryer tends to cause thermal profiling, or warping, of the roll, which might impact the reliability and/or throughput of the system. Moreover, thermal profiling of a roll might also unnecessarily wear on the cutter cells of the cutter roll due to the misalignment or non-uniform surface of the transfer/anvil roll, resulting in unnecessary wear and tear on the roll and decreased machine reliability.

Moreover, some three-roll systems also suffer from a variety of negative limitations. Specifically, in a typical three-roll system, a continuous sheet of material is conveyed through a plurality of rolls, which cuts the sheet of material into widths of dough ribbons and transfers those ribbons to a fryer for frying to a crisp state. The ribbons are then removed from the fryer and separated into a individual chips. One of the problems associated with these systems is that a ribbon of dough may stick together resulting in unfried or partially fried chips, or, a ribbon of dough may be left in a fryer for too long resulting in burned chips. The process also requires further post-frying cutting or breaking procedures to separate individual chips or products. These limitations result in excessive waste and decreased machine throughput.

In view of these negative limitations, it would be advantageous to provide an-line rotary cutting and conveying system that eliminated the negative effects of thermal profiling and the other limitations of a two-roll or three-roll rotary system. Moreover, it would be advantageous to provide a system that conveyed individual chips to a fryer to improve the quality and uniformity of chips, reduce waste associated with frying a ribbon of dough and improve the overall speed and through-put of a system.

The system of the present invention provides a plurality of at least three rolls such as an anvil roll, a cutter roll and a transfer roll, such that the anvil roll and cutter roll are not in contact with a fryer. As a result, while thermal profiling might exist in a system, specifically in a transfer roll, it should not impact the cutting operation or the reliability of the system because the transfer roll is isolated from both a cutter and anvil rolls. The Cutter roll of the present invention also has a plurality of cutter cells each configured to cut and receive individual product portions of the material and to transfer those individual portions to a transfer roll where they can be transferred to a fryer. As such, problems associated with processing ribbons of dough can be alleviated. Additionally, the system contemplated by the present invention improves speed and throughput, extends cutter cell life and improves quality overall.

### SUMMARY OF THE INVENTION

In one embodiment of the invention, an in-line cutting and conveying system for cutting and processing a plurality of individual product portions from a sheet of material comprises an anvil roll having an outer surface configured to receive and support a sheet of material. The system also comprises a cutter roll positioned adjacent to said anvil roll, and the cutter roll having a plurality of spaced cutter cells each configured to interface with the anvil roll in use, such that the cutter roll cuts and receives individual product portions of the material positioned on the outer surface of the anvil roll. A transfer roll is also positioned adjacent to the cutter roll to receive the individual product portions of material from the cutter roll.

In another embodiment of the invention, an in-line cutting and conveying system for cutting and processing a plurality of individual product portions from a sheet of material comprises an anvil roll having an outer surface configured to receive and support a sheet of material. The anvil roll also comprises a cooling channel positioned to maintain the outer surface of the anvil roll at a desired temperature. A cutter roll is also positioned adjacent to the anvil roll. The cutter roll comprises a plurality of spaced cutting cells each configured to interface with the anvil roll in use to cut and receive an individual product portion of the material positioned on the outer surface of said anvil roll. The system also comprises a transfer roll positioned adjacent to said cutter roll.

In another embodiment of the invention, an in-line cutting and conveying system comprises a plurality of rolls, a carrier system comprising a plurality of receiving zones and a sensing system in communication with said carrier system. The sensing system is configured to index a transfer of a plurality of portions of a material from one roll of said plurality of rolls to the carrier system.

In another application of the invention, a method of processing material is provided comprising the steps of providing an anvil roll comprising an outer surface configured to provide a cutting surface for receiving and supporting a continuous sheet of material on at least a portion of such outer surface. A cutter roll is positioned adjacent to said anvil roll, and comprises a plurality of spaced cutting cells on an outer surface of the cutter roll, each configured to interface with the anvil roll for separating a plurality of portions of the material sheet positioned on said outer surface of the anvil roll and receiving the individual portions of material. Consequently, a plurality of individual product portions are separated from the sheet of material positioned on the outer surface of the anvil roll and the individual portions of material are received in respective cutting cells. A transfer roll is provided having an outer surface and positioned adjacent to the cutter roll, such that individual portions of material from the outer surface of the cutter roll are transferred to the outer surface of the transfer roll.

Still other objects, advantages and novel features of the present invention will become apparent to those skilled in the art from the following detailed description, which is simply, by way of illustration, various modes contemplated for carrying out the invention. As will be realized, the invention is capable of other different aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be better understood from the following description, taken in conjunction with the accompanying drawings, in which:

FIG. 1 depicts an exemplary schematic view of an embodiment of an in-line rotary cutting and conveying system of the present invention;

FIG. 2A depicts an exemplary end view embodiment of an in-line rotary cutting and conveying system in accordance with the present invention;

FIG. 2B depicts a side view schematic of an exemplary embodiment of an plurality of gears that might be utilized by an in-line rotary cutting and conveying system in accordance with the present invention;

FIG. 3A depicts a cross-sectional view of an exemplary anvil roll in accordance with the present invention;

FIG. 3B depicts an exemplary cross-sectional view of an embodiment of a heating/cooling manifold system as contemplated by the present invention;

FIG. 4 depicts an exemplary cutter roll as utilized in an in-line cutting and conveying system in accordance with the present invention;

FIGS. 5A and 5B depict enlarged plan and cross-sectional views of an exemplary embodiment of a cutter block in accordance with the present invention;

FIGS. 6A and 6B depict an exemplary cross-sectional elevational and end views of an embodiment of a cutter roll in accordance with the present invention;

FIG. 7 depicts an exemplary embodiment of a cutter roll manifold system in accordance with the present invention;

FIGS. 8A and 8B depict an exemplary embodiments of a transfer roll of an exemplary in-line rotary cutting and conveying system of the present invention;

FIG. 9 illustrates an exemplary transfer roll manifold end-cap assembly of the present invention;

FIG. 10A depicts an elevational view of an exemplary two-zone cutter roll manifold system in accordance with the present invention;

FIG. 10B depicts an elevational view of an exemplary two-zone transfer roll manifold system as contemplated by the present invention;

FIGS. 11A and 11B depict an elevational and end view, respectively, of an exemplary four-zone cutter roll manifold system in accordance with the present invention;

FIGS. 12A and 12B illustrate an elevational and end view, respectively, of an exemplary four-zone transfer roll manifold system in accordance with the present invention;

FIG. 13 diagrammatically illustrates an alternative exemplary embodiment of the present invention;

FIGS. 14A and 14B depict alternate exemplary embodiments of a manifold end cap assembly as contemplated by the present invention;

FIG. 15 depicts an alternate schematic view of an embodiment of an in-line rotary cutting and conveying system in accordance with the present invention; and

FIG. 16 is a schematic depiction of the anvil roll, cutter roll and transfer roll aspects of the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

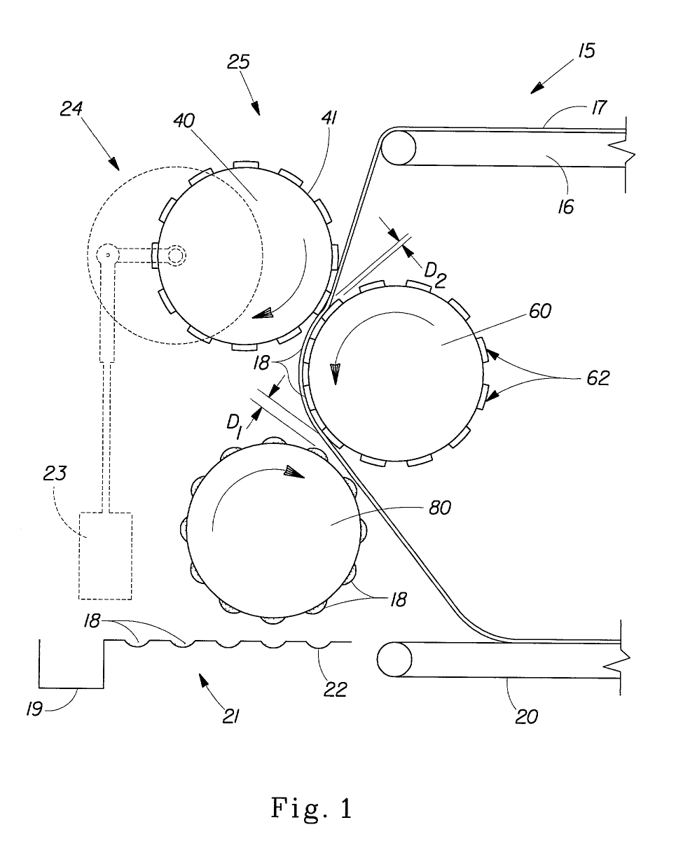

FIG. 1 depicts an exemplary schematic view of an embodiment of an in-line rotary cutting and conveying system 15 in accordance with the present invention. As a general overview and as will be more fully described in detail, an in-line rotary cutting and conveying system 15 might be configured to cut and convey a continuous sheet 17 of material such as a dough sheet for manufacturing potato chips or other products.

An in-line rotary cutting and conveying system 15 might comprise an in-feed conveyor 16 for transferring a sheet 17 of material such as a relatively continuous dough sheet to a cutting and conveying system 15. In-feed conveyer 16 might transfer sheet 17 of material to at least a portion of an outer surface 41 of an anvil roll 40. A cutter roll 60 is shown as positioned adjacent to the anvil roll 40 and provided with a plurality of cutter cells 62 configured to interface with a continuous sheet of material on an outer surface of the anvil roll. As used herein, the term “interface” is contemplated to mean that a cutter cell might be configured to separate a portion of material from a continuous sheet of material 18 positioned on an anvil roll. In other words, a cutter roll comprising a plurality of cutter cells 62 might be configured to cut and receive a plurality of individual product portions of a material, such as a dough portion 18, from a continuous sheet of material positioned on an outer surface of an anvil roll 40. While such interface might include actual contact of cutting edges of a cell 62 with the outer surface 41 of the anvil roll, such contact is not necessarily required and might advantageously be optimized to minimize wear of interacting surfaces.

A transfer roll 80 might be positioned adjacent to a cutter roll 60 and adapted to receive the individual product portions 18, such as dough portions from the cutter roll. Transfer roll 80 might also be configured to transfer the individual dough portions 18 received on a transfer roll to a carrier system 21 configured to convey the dough portions 18 to a fryer 19 for frying to crisp state. A take away conveyor 20 might convey scrap material, or the unused portion of a dough sheet 17, to a reprocessing or recycle bin (not shown).

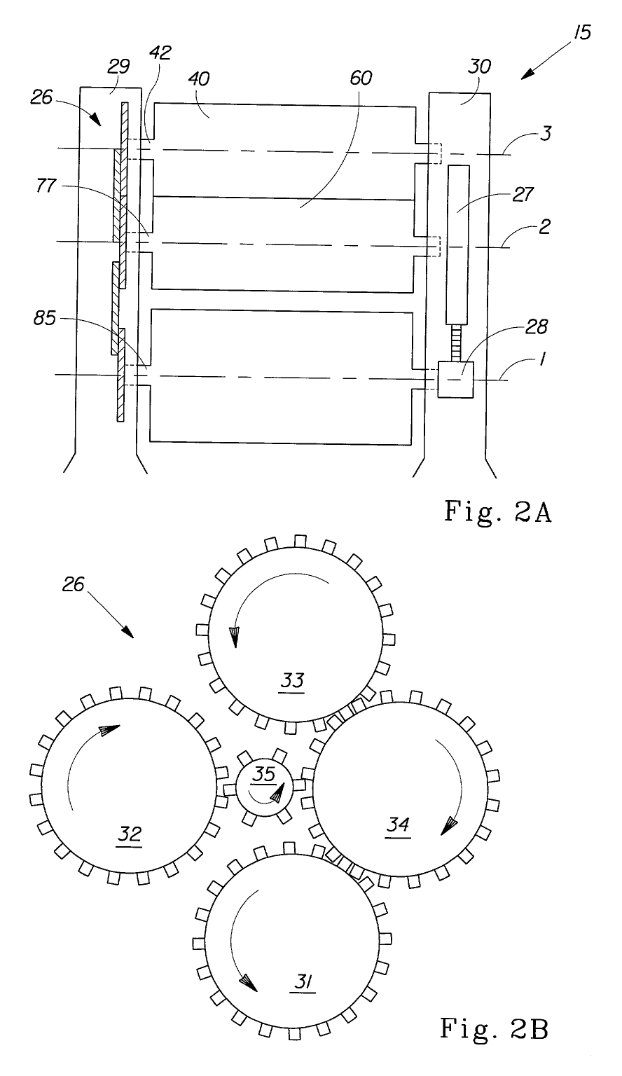

FIG. 2A depicts an exemplary embodiment of an in-line rotary cutting and conveying system 15 in accordance with the present invention. In more detail, it is contemplated that an in-line rotary cutting and conveying system 15 might comprise a plurality of rolls, such as an anvil roll 40, a cutter roll 60 and a transfer roll 80, interconnected by plurality of gears 26 and driven by a motor 27 such as a servo motor connected through an appropriate gear box 28 and driven by shaft 85.

As mentioned, in an exemplary embodiment of the invention, a servo motor 27 might be provided to drive in-line cutting and conveying system 15. In particular, output from motor 27 is transferred via gear box 28 and shaft 85 to cause a transfer roll 80 to rotate. In other words, a servo motor 27 might cause transfer roll 80 having a shaft 85 to rotate about axis 1-1 as depicted in FIG. 2A. A plurality of associated gears 26 might be positioned opposite a gear box 28 and configured to simultaneously drive anvil roll 40 and cutter roll 60. It is contemplated that anvil roll 40 and cutter roll 60 might rotate about shafts 42 and 77, respectively (e.g. about axis 2-2 and 3-3, respectively).

An in-line rotary cutting and conveying system 15 might further comprise a left support frame 29 and a right support frame 30 configured to provide the necessary structural support for each roll 40, 60 and 80 and for the plurality of gears 26, servo motor 27 and gear box 28. Transfer roll 80 might be held in a fixed location relative to supports 29 and 30 regardless of whether an in-line cutting and conveying system 15 is at rest or is in operation. Similarly, cutter roll 60 might also be held in a fixed location relative to supports 29 and 30 while the cutter roll 60 is in operation, or could be configured to be adjustable with respect to a transfer roll 80 while a system 15 is not in operation. It is contemplated that a cutter roll 60 might be configured to be adjustable with respect to a transfer roll 80, for example, to accommodate for changes in speed associated with a transfer of individual dough portions 18 from a cutter roll 60 to a transfer roll 80.

As best illustrated in FIG. 1, an anvil roll 40 might be held in a fixed location in a rest position 24 as depicted by the dotted-lines, but in an operating position 25 an anvil roll 40 might be positioned to lie substantially against a cutter roll 60 such that a cutter roll 60 might bear substantially the entire load of an anvil roll 40. In other words, as depicted in FIG. 1, anvil roll 40 might be moved to a position such that the weight of the roll 40 rests primarily on the cutter roll 60. In more detail, in its rest position 24, anvil roll 40 might be positioned adjacent to, but not in contact with a cutter roll 60. However, an anvil roll 40 might be configured with a pneumatic cylinder 23 at each end of the anvil roll, such that upon activation of the cylinder 23, the cylinder moves anvil roll 40 to an operating position 25. In other words, in an operating position 25, anvil roll 40 could be repositioned to interface with a portion of a cutter roll 60 such that any material positioned on an outer surface 41 of an anvil roll 40 could be separated by cutter roll 60. It should be recognized that any variety of mechanical configurations could be implemented to move an anvil roll 40 to and from a spaced rest position 24 and an operating position 25 adjacent cutter roll 60. Other alternatives might include incorporating a hydraulic cylinder or a providing an air-over-oil cylinder, wherein the cylinder might be filled with an oil and compressed air.

FIG. 2B depicts a side view of an exemplary embodiment of an plurality of gears 26 that might be utilized in accordance with the present invention. Specifically, gears 26 might comprise a transfer roll gear 31, a cutter roll gear 32, and an anvil roll gear 33 each drivingly connected to its respective roll 80, 60 and 40. The plurality of gears 26 might also comprise idler gears 34 and 35 to change the direction of a cutter roll 60 and an anvil roll 40. For example, it is contemplated that a servo motor 27, in contact with gear box 28, might cause a transfer roll gear 31 and an associated transfer roll 80 to rotate in a counter-clockwise direction as shown. Idler gear 34 in contact with transfer roll gear 31 might rotate in a clockwise direction and idler gear 35 in contact with idler gear 34 might rotate in a counter clockwise direction. As a result, anvil gear 33 in contact with idler gear 34 might cause anvil roll 80 to rotate in a counter clockwise direction and cutter roll gear 32 in contact with idler gear 35 might cause cutter roll 60 to rotate in a clockwise direction. It should be recognized that the above gear arrangement and servo motor connection is only one example of any number of combinations that could be used to apply the teachings of the present invention.

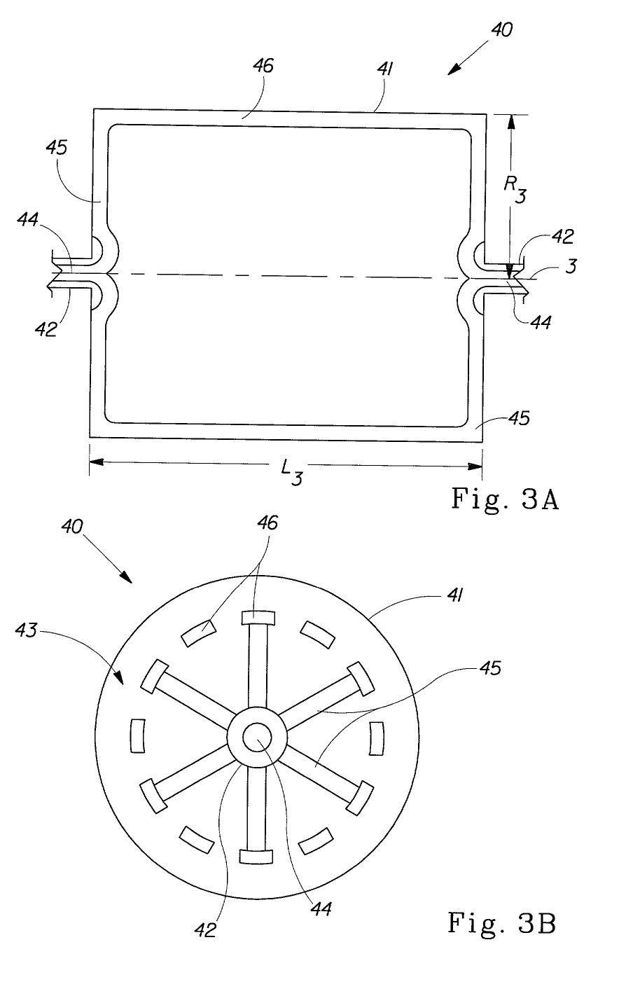

FIG. 3A depicts a cross-sectional view of an exemplary anvil roll 40 which might be utilized in accordance with the present invention. It is contemplated that such an anvil roll 40 might comprise a substantially cylindrical shape and have a predetermined length (e.g. L₃) and a predetermined radius (e.g. R₃). It should be recognized that a length L₃ could be any length that provides a sufficient continuous cutting surface configured to receive and support a sheet of material to be processed on its outer surface.

An anvil roll 40 might be constructed from any of a variety of materials, but in an exemplary embodiment of the invention an anvil roll 40 might be constructed from hardened steel. More particularly, it is contemplated that an outer surface 41 of an anvil roll might be constructed from hardened steel to provide a long-lasting surface. It should be recognized that anvil roll 40 might generally be configured to rotate such that an outer surface 41 of an anvil roll 40 provides a substantially continuous interfacing surface for a cutter roll.

In an exemplary embodiment of the invention, anvil roll 40 might be high precision ground to improve the accuracy and reliability of a system 15. Specifically, it is contemplated that for dough processing applications, for example, a high precision grinding process might provide a radial tolerance of an anvil roll of within plus or minus 0.2%. In other words, every part of an outer surface 41 of an anvil roll 40 might be equidistant from a center of an anvil roll within 2/1000th of an inch. It should be recognized that a higher or lower precision might be implemented if desired.

In another embodiment of the invention, system 15 might comprise a cooling or heating system designed to prevent a dough sheet 17 from sticking to an outer surface of anvil roll 40 while a system 15 is in operation. For example, in an exemplary embodiment of the invention, an anvil roll 40 might comprise a temperature control manifold system 43 for providing temperature control of an outer surface 41 of the anvil roll 40. Other methods of preventing a dough sheet from sticking to an outer surface might include providing an airbar positioned adjacent to an anvil roll for blowing air underneath the dough sheet, providing external cooling/heating such as spraying water or other liquid or gas on either or both an anvil roll or a dough sheet, or coating a dough sheet and/or a roll with flour or some other substance to prevent sticking.

In an exemplary embodiment, however, a temperature control manifold system 43 might comprise a cooling channel 44 configured to allow a cooling substance, such as cooled water, to fill a manifold system 43 for the purpose of preventing a dough sheet from sticking to the anvil roll. While it is contemplated that manifold system 43 might be configured to provide a cooling liquid to an outer surface of an anvil roll, it should be understood that a manifold system is not limited to this embodiment and that a manifold system might be provided with a heated substance for some applications. Nonetheless, manifold system 43 might be configured to provide a selective flow of a cooling and or heating substance for the purpose of maintaining a uniform and/or constant desired temperature on outer surface 41 of anvil roll 40. Although, it should be recognized that a cooling channel 44 might be positioned in any location, that provides access to a manifold system 43, in an exemplary embodiment of the invention, a cooling channel 44 might be configured within a shaft 42 of an anvil roll 40. For example, a shaft 42 might be hollowed and configured with an opening at each end of the shaft to allow a cooling substance to flow therethrough. It should further be recognized that the direction of flow of a substance through a shaft 42 or a manifold system 43 could be in either direction, so long as a manifold system 43 provides for temperature control of an outer surface 41 of anvil roll 40. Moreover, a shaft could be of virtually any configuration such as spiral, multi-path, counter-current or the like for the intended purpose of cooling and/or heating an outer surface of an anvil roll and maintaining the surface at a constant and desired temperature.

FIG. 3B depicts an exemplary embodiment of a temperature control manifold system 43 in accordance with the present invention. While such a manifold system 43 might be of any variety of configurations, in an exemplary embodiment of the invention, a manifold system 43 might comprise a plurality of vanes 45 in fluid communication with a cooling channel 44. A plurality of vanes 45 might extend radially outward from a cooling channel toward outer surface 41 of anvil roll 40. A substance, such as water entering through cooling channel 44 might flow through each of a plurality of vanes 45 toward outer surface 41 of the anvil roll 40.

A manifold system 43 might further comprise a plurality conduits 46 in fluid communication with vanes 45. Conduits 46 might be positioned near outer surface 41 of anvil roll 40 and across nearly the entire length (or at least the part used to process material) of the anvil roll for the purpose of heating or cooling the outer surface. A fluid substance flowing through vanes 45 might enter conduits 46 and flow through the conduits toward an opposite end of an anvil roll 40. The substance might then flow through vanes 45 positioned toward an opposite end of an anvil roll 40 and flow out of the cooling channel 44. It should be recognized that manifold system 43 should be designed so as not to compromise the structural integrity of outer surface 41 of anvil roll 40. Additionally, it should be recognized that, for our dough processing example, a heating or cooling substance might be water, gas or some other fluid or substance that is food grade compatible.

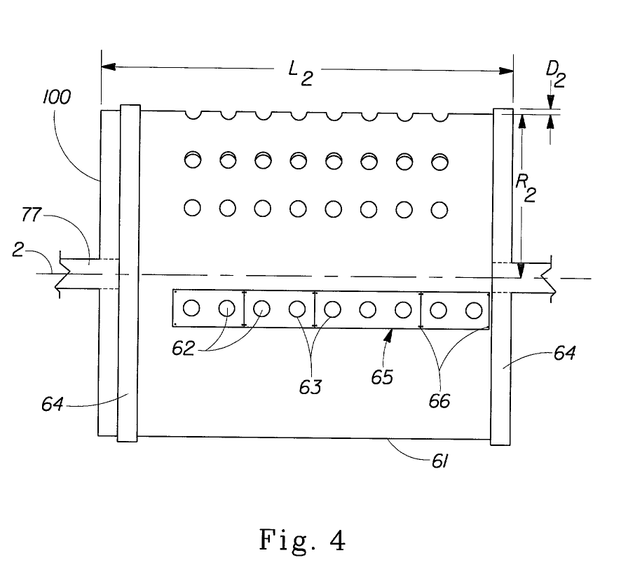

FIG. 4 depicts an exemplary cutter roll 60 as might be utilized in an in-line rotary cutting and conveying system 15 in accordance with the present invention. Cutter roll 60 might comprise a substantially cylindrical shape and have a predetermined length L₂ and a predetermined radius R₂. Although length L₂ could be virtually any length that accommodates separating of a sheet 17 of material, in an exemplary embodiment of the invention, length L₂ might be substantially equal to or slightly shorter than length L₃ of anvil roll 40. In this way, cutter roll 60 and anvil roll 40 might cooperate in separating a sheet 17 of material such as a dough sheet into a plurality of dough portions 18. As used herein, the term “separating” is contemplated to mean causing a dough portion to be divided from a dough sheet through, individually or in combination, cutting, stretching, scoring, and/or vacuuming and the like. A cutter roll 60 might separate a plurality of portions of material from a sheet of material by cutting the material with cutters 42. Other alternative methods of cutting might include, by way of example only, ultrasonic cutting, laser cutting, water jet cutting, air jet cutting and the like. It should be recognized that these alternatives might require only slight constructional changes that are typically well known in the art, to achieve enablement of a system 15. It should also be recognized that although a cutter roll 60 could be constructed from virtually any hard material, in an exemplary embodiment of the invention, a cutter roll 60 might be constructed from hardened steel material.

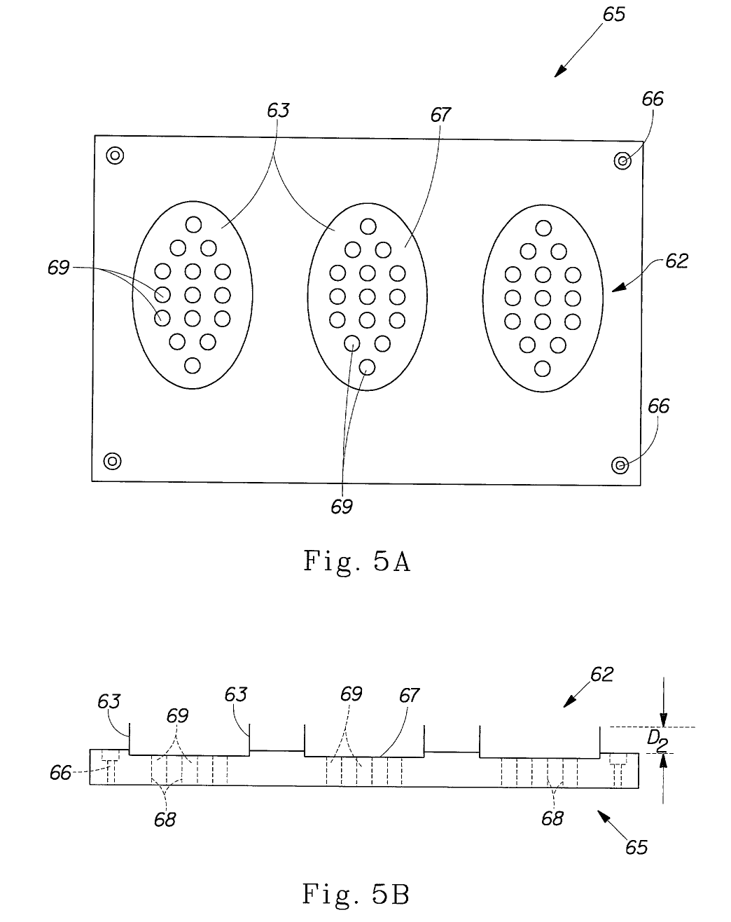

In a non-limiting embodiment of the invention, it is contemplated that a cutter roll 60 might be provided with a plurality of bearing lands 64 circumferentially positioned about the cutter roll. The bearing lands 64 might extend radially beyond a radius R₂ of a cutter roll 60 such that bearing lands 64 extend a height d₂ above a cutter roll 60. As a result, in an operating position, bearing lands 64 might be configured to contact a portion of an anvil roll to maintain a predetermined minimum spacing, d₂ as best illustrated in FIGS. 1 and 5B, between an anvil roll and a cutter roll. In more detail, it is contemplated that cutter roll 60 might comprise two bearing lands 64, one positioned at each end of cutter roll for the purpose of contacting anvil roll 40 when the anvil roll is positioned in its operating position 25. A bearing land 64 might be formed as an integral part of a cutter roll and high precision ground to achieve smooth contact between each of the bearing lands and an anvil roll. Additionally, a bearing land 64 might be of a sufficient width so that a substantial portion of an anvil roll's weight or load might rest on the bearing lands when an anvil roll 40 is in an operating position. In an exemplary embodiment of the invention, a bearing land 64 might comprise a ring shape and the portion of the bearing land that is configured to contact the anvil roll could be of any shape including a square, semi-circle, and the like.

It is further contemplated that a cutter roll 60 might comprise a plurality of spaced cutter cells 62 positioned on outer surface 61 of the cutter roll such that a plurality of cutter cells might interface with a material positioned on a portion of an outer surface 41 of anvil roll 40 and between anvil roll 40 and cutter roll 60 when anvil roll 40 is in its operating position. The cutter cells 62 could form any variety of cutting configuration including cross-machine, machine, index, intermeshed, nested and the like.

In operation, a sheet 17 of material positioned on an outer surface 41 of an anvil roll 40 might be cut by a plurality of cutter cells 62 each having a cutting blade 63. In more detail, a plurality of cutter cells 62 each having a cutting member or cutting blade 63 might be positioned between the bearing lands 64 located on each end of a cutter roll 60. A cutting blade 63 might be provided in a substantially continuous shape about the periphery of each cell and might extend radially outward from outer surface 61 of cutter roll 60 a distance d₂, or a distance substantially equal to, or slightly less than, a distance bearing lands 64 extend radially outward from an outer surface of a cutting roll. The shape of cutting member 63 largely determines the shape of the individual product portions as removed by the cutter cell 62 from sheet 17.

In an exemplary embodiment of the invention, a cutting blade 63 might also be constructed from a hardened steel material to accommodate for the stresses associated with continuously cutting individual portions of dough from a dough sheet. However, it should be recognized that utilization of a plurality of bearing lands 64 might prevent unnecessary wear or unnecessary dulling of cutting members 63 because the bearing lands 64 should bear nearly the entire load of an anvil roll 40 and might prevent excessive contact between a cutting blade and the anvil roll. As a result, cutting blades 63 might not need to be replaced or sharpened as often as cutting blades of traditional in-line rotary cutting machines.

FIG. 5A depicts an exemplary embodiment of a cutter block 65 having a plurality of individual and spaced cutter cells 62. While it might be recognized that a plurality of cutter cells 62 might be machined onto and made an integral part of an outer surface of a cutter roll 60, in this exemplary embodiment of the invention, it is contemplated that a cutter block 65 might comprise a plurality of cutter cells 62 configured to be mounted on a cutter roll 60. In an exemplary embodiment, it is contemplated that a cutter block 65 might be bolted on a cutter roll 60 by bolts 66 or otherwise fastened to a cutter roll 60 by some other type of fastener. In any case, it should be recognized that a cutter block 65 might be constructed from any hard material such as a hardened steel.

In an exemplary embodiment of the invention, it is contemplated that cutter blocks 65 are interchangeable. As used herein, the term “interchangeable” is contemplated to mean that cutter blocks 65 are modular, replaceable and removable. Specifically, it is contemplated that cutter blocks 65 are modular in that any cutter block could be positioned in virtually any position around the circumference of a cutter roll 60. Additionally, each cutter block 65 might be configured to be removed to be refurbished or replaced if desired. A purpose of providing separate and interchangeable cutter blocks 65 to be mounted on a cutter roll 60 might be to allow a cutter block 65 to be changed or refurbished due to dulling of a cutter blade 63, a change in design of a cutter blade or cell, to allow for longer life of the anvil roll, to enable cutter blocks for use with different products of processes, or for any other variety of reasons.

In an exemplary embodiment of the invention, a cutter block 65 might comprise one to six cutter cells, and in the exemplary embodiment shown in FIG. 5A, cutter block comprises three cutter cells arranged in a spaced side-by-side configuration. It should be recognized that a plurality of cutter blocks 65 might be positioned around an outer surface 61 of a cutter roll 60 to provide a repeating and/or continuous cutting pattern. For example, in a non-limiting embodiment of the invention, a length L₂ as illustrated in FIG. 4, of a cutter roll 60 might comprise about four cutter blocks positioned end-to-end, forming a row of cutter cells, and about 14 cutter blocks positioned circumferentially about an outer surface 61 of a cutter roll 60. In this way, a cutter roll 60 might comprise 168 cutter cells positioned around an outer surface 61 of a cutter roll 60. It should be recognized that the number of cutter cells 62 positioned around an outer surface 61 of a cutter roll 60 might vary significantly depending on the number of cutter cells 62 per cutting block 65, the number of cutter blocks positioned along a length L₂ of a cutter roll 60 and the number of cutter blocks 65 positioned around a circumference of a cutter roll 60. In an exemplary embodiment of the invention, a cutter roll 60 might comprise between about 156 and about 224 cutter cells 62 (12 to 16 cutter cells spaced along length L₂, and 13 to 14 cutter blocks equally spaced about a circumference).

As depicted in FIG. 5B, each cutter cell 62 might comprise an outer-edge cutting member or blade 63 that might be of any variety of geometric shapes, such as a square, rectangle, triangle, star, circle and the like. It should also be recognized that each cutting member or blade 63 might be defined by a continuous cutting edge or a plurality of cutting edges. However, in an exemplary embodiment of the invention, for processing potato chip type products, a cutting blade 63 might comprise a substantially oval shape. Moreover, each cutter cell 62 positioned on cutter block 65 might further comprise an inner surface 67 radially within and recessed relative to cutter blade 63. Each cutter cell 62 might also comprise a plurality of ducts 68 that form airflow apertures 69 on inner surface 67 of cutter block 65. In general and as will be described in more detail, airflow apertures 69 might be configured to provide selective pressure control or airflow to inner surface 67 of each cutter cell 62. As used herein, the term “airflow” or “pressure control” is contemplated to mean that either underpressure (i.e., vacuum) or pressure of air, or some other type of fluid or gas, might be selectively provided to airflow apertures 69 on inner surface 67 of each cutter cell 62. Generally, in a vacuum state, airflow apertures 69 are configured to vacuum or suction dough portions 18 cut from a sheet 17 of material positioned on an outer surface 41 of an anvil roll 40 and cut by a plurality of cutter cells 62 on a cutter roll 60. In other words, in a vacuum state, after cutter blades 63 cut a plurality of dough portions 18 from a sheet 17 of dough material, a plurality of airflow apertures 69 can provide vacuum suction or underpressure to the cut dough portions to help hold the cut dough portions 18 adjacent to an inner surface 67 of cutter cell 62. In a pressurized state, airflow apertures 69 can similarly provide pressurized air or some other gas, causing any cut dough portions 18 held in, or positioned on, a cutter cell 62 to be blown off or out of the cutter cell.

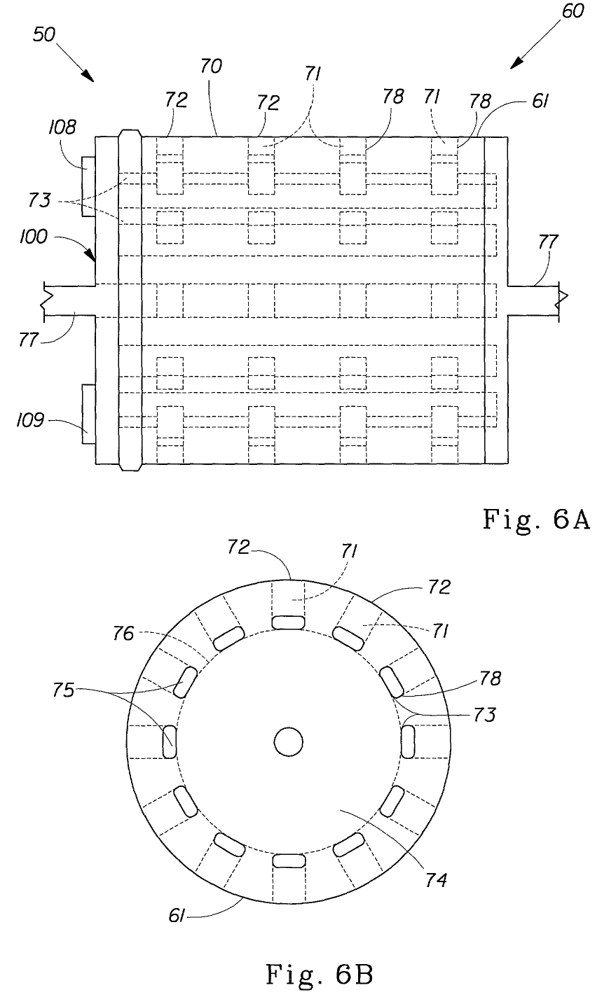

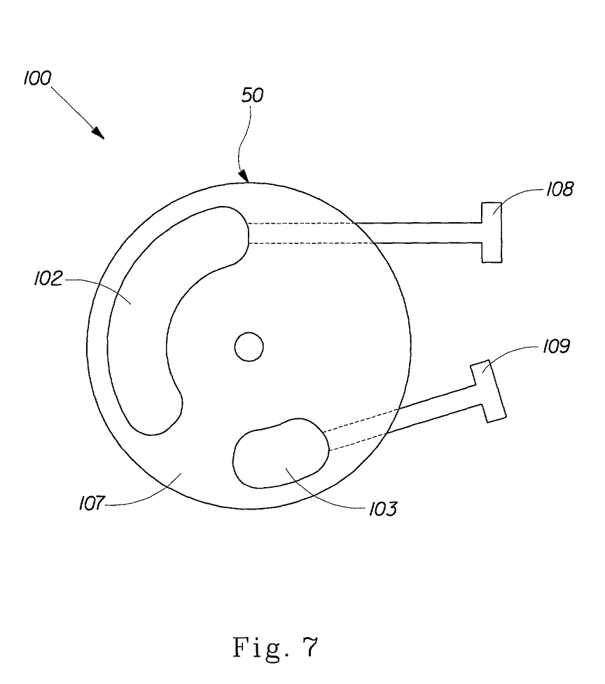

FIGS. 6A, 6B and 7 depict an exemplary embodiment of a cutter roll 60 comprising a cutter manifold system 50, which might further comprise an internal channel system 70 and an end cap assembly 100. As will be explained in more detail, it is contemplated that there are numerous ways to provide such cutter manifold systems 50. For simplicity purposes, a single-zone cutter manifold system 50 comprising an internal channel system 70 and an end cap 100 will first be described and then a two-zone system and a four-zone system will be described as examples of alternate embodiments of the invention.

FIG. 6A and 6B depict a single-zone internal channel system 70 that might be configured within a portion of a cutter roll 60 to provide for distribution of pressure control to a plurality of airflow apertures 69 located on inner surface 67 of a cutter cell 62. In more detail, a cutter roll 60 might be configured with a plurality of internal orifice channels 71 designed to provide either pressure or vacuum to individual cutter cells via a plurality of airflow apertures 69 located on inner surface 67 of cutter cell 62. In a non-limiting embodiment of the invention, each internal orifice channel 71 might extend radially inward from an outer surface 61 of a cutter roll 60. One end of each internal orifice channel 71 might form an orifice 72 adjacent outer surface 61 of cutter roll 60 such that orifice 72 might align with a plurality of ducts 68 associated with a cutter cell 62. In this way, either vacuum or pressure might be provided to a plurality of apertures 69 associated with a particular cutter cell 62.

A second end 78 of an internal orifice channel 71 might be in air flow communication with a main airflow channel 73. A main airflow channel 73 might be positioned on an inner perimeter 76 of a cutter roll 60, shown in the example as being positioned substantially parallel to outer surface 61, and across nearly the entire length L₂ of a cutter roll 60 such that an end of channel 73 might terminate in an opening 75 provided in side wall 74 of a cutter roll 60. In this way, airflow provided at an airflow opening 75 might flow through a main airflow channel 73 to each of a plurality of internal orifice channels 71 and be provided at each of a plurality of orifices 72 located on an outer surface 61 of a cutter roll 60. In an exemplary embodiment of the invention, a cutter block 65 having three cutter cells 62 might be positioned such that a plurality of ducts 68 associated with each cutter cell 62 can be in fluid communication with an orifice 72.

In an exemplary embodiment of the invention, it is contemplated that a cutter roll 60 might comprise about 14 main airflow channels 73 positioned about an inner perimeter 76 of cutter roll 60. It should be recognized that the number of main airflow channels 73 can vary and that the number of main airflow channels present in a cutter roll 60 might advantageously correspond with the number of cutter blocks 65 positioned around outer surface 61 of cutter roll 60. As will be appreciated, the number of cutter cells 42 positioned around an outer surface 61 of a cutter roll 60 can vary significantly depending on design choice.

FIG. 7 illustrates an exemplary manifold system end cap assembly 100 configured to provide selective pressure or vacuum through an internal channel system 70. An end cap assembly 100 of a manifold system 50 might thereby distribute vacuumed or pressurized air to a plurality of airflow openings 75 positioned around an inner perimeter 76 of a cutter roll 60. An end-cap assembly 100 of cutter manifold system 50 might be held in a stationary position while a cutter roll 60 rotates thereabout. To reduce frictional heat, and thus the potential affects of thermal profiling or warping of a cutter roll 60 resulting from a cutter roll 60 rotating against a stationary end cap assembly 100, a cutter roll 60 might be provided with a plastic covering such as sold under the Rulon name, and, as available from Tri*Plastics, of Charlotte, N.C. Such a covering might be directly mounted on a cutter roll 60 such that any frictional heat from might be transferred to the covering rather than to the cutter roll 60.

In any event, to achieve an air-tight seal between the end-cap assembly 100 and the cutter roll 60, a manifold end cap assembly 100 might be configured with air cylinders (not depicted) configured to contact the outer surface of the end cap assembly and compress the assembly 100 against a cutter roll 60. It should be recognized that there are a variety of mechanical configurations known in the art that might allow a stationary object, such as an end cap assembly 100 to contact a rotating object such as a cutter roll 60 and provide an air-tight seal. The use of air cylinders is one such approach.

An air tight seal provided between an end cap assembly 100 and a cutter roll 60 might allow end cap assembly 100 to distribute air flow throughout an internal channel system 70. Specifically, end cap assembly 100 might be configured with a plurality of airflow cavities 102 and 103 positioned around an interior surface 107 of assembly 100, and might further comprise a plurality of airflow connectors 108 and 109 capable of being connected to a vacuum and/or a pressure source for providing pressure control throughout end cap assembly 100. In an exemplary embodiment of the invention, an airflow connector 108 might be configured to be connected to a vacuum pump for providing vacuuming suction at an airflow cavity 102 of an end cap assembly, and an airflow connector 109 might be configured to be connected to a pressurized pump for providing pressurized airflow at airflow cavity 103. It should be recognized that the configuration of cavities could vary depending on design choice and that the configuration of end cap assembly is not limited to two cavities but could comprise any number of cavities including only one. For example, in one embodiment, an airflow cavity might comprise an additional cavity for the purpose of internal roll cleaning. An additional cavity might be configured with pressure so that after a dough portion 18 is blown off a cutter, an additional burst of air might ensure each of the plurality of apertures 69 located on a cutter block 65 is free and clear from any dough or debris. Additionally, it should be recognized that the cavities do not have to provide pressure or vacuum, rather in some embodiment, the cavities might not be provided with either.

In a non-limiting embodiment of the invention, a cutter roll 60 might rotate against a siationary end cap assembly such that airflow opening 75 positioned on inner side wall 74 of cutter roll 60 might align with airflow cavities 102 and 103 of stationary end cap assembly 100. In such an exemplary embodiment, cutter roll 60 might rotate in a clockwise direction such that airflow opening 75 might first align with an airflow cavity 102. As a cutter roll continues to rotate airflow opening 75 might then align with airflow cavity 103. Thus, each airflow opening 75 positioned around an inner side wall 74 of cutter roll 60 might first be provided with a vacuum or underpressure as airflow opening 75 aligns with airflow cavity 102 and then provided with pressure as airflow opening 75 aligns with airflow cavity 103.

From the foregoing, it should be recognized that in operation a cutter roll 60 night rotate against an anvil roll 40 carrying a sheet of material, such as a dough sheet, on its outer surface 41. As the rolls rotate, a plurality of oval blades 63 positioned on outer surface 61 of cutter roll 60 interact with anvil roll 40 and separate a plurality of dough portions 18 in the shape of the cutter cells (e.g. oval) from a dough sheet positioned on an outer surface of anvil roll 40. Simultaneous with separating a plurality of dough portions 18, airflow opening 75 of cutter roll might align with airflow cavity 102 of an end cap assembly 100, thereby causing a plurality of airflow apertures 69 of cutter cells 62 to be provided with a vacuum or relative underpressure. In other words, a row of cutter cells 62 might be configured to receive an underpressure or vacuum. The underpressure might help hold each of the newly cut individual dough portions 18 against an inner surface 67 of a cutter cell 62 such that a plurality of the newly cut oval dough portions 18 might be received, or “vacuumed”, into a corresponding row of cutter cells 62. A vacuum suction or underpressure might continue to hold the plurality of dough portions against the inner surfaces of such cutter cells 62 until an airflow opening 75 of cutter roll 60 aligns with an airflow cavity 103 of end cap assembly 100. As described above, airflow cavity 103, provided with pressurized air might blow or eject each of a plurality of dough portions 18 out of, or off of, each of a plurality of cutter cells 62 such that an entire roll of individual dough portions might be blown off or transferred off a cutter roll. This “blow off” or ejection process can be used to augment, or can be augmented by, gravity if the transfer takes place when cutter cells 62 are facing in a relatively downward direction (such as schematically shown in FIG. 1).

It should be recognized that while being firmly received within a cutter cell 62, it is contemplated that a system 15 might further comprise other shape forming or printing machines configured to interact with each individual portion of material prior to being transferred to a transfer roll 80. For example, a name or logo could be imprinted on each individual portion.

An end cap assembly 100 might also be capable of being manually adjusted relative to a cutter roll 60. In particular, prior to operation of a system 15, an end cap assembly 100 might be configured to be rotated to change the positioning of airflow cavities 102 and 103. For example, if an operator desires to change the positioning of a area at which a cutter roll 60 blows off or ejects a plurality of dough portions 18, an end cap assembly 100 might be rotated prior to operation of system 15.

In one alternative embodiment herein, the anvil roll 40 is placed in the center position providing the same vacuum and pressure capabilities as previously explained with the cutter roll 60. In other words, the anvil roll 40 and the cutter roll 60 may switch positions in the process, and the anvil roll 40 and cutter roll 60 exchange functions; i.e., the vacuum and pressure capabilities now reside in the anvil roll 40. Note that in this embodiment, the cutter roll 60 may no longer have the vacuum capability although a pressure capability may still reside with the cutter roll 60. In practice, a product sheet 17 (e.g., dough, potato, etc.), as it moves toward the anvil roll 40 herein, is vacuumed onto the anvil roll surface 41 prior to interfacing the cutter roll 60, the cutter roll 60 now being in the upper position. Herein, the rotary cutter roll cells 62 cut the shaped dough pieces 18 as before, however the dough pieces 18 and the unused portion of dough sheet 17 would stay vacuumed onto the anvil roll surface 41. The anvil roll 40 would require the use of the manifold system 50 as used in the previous explanation of the cutter roll 60 to permit blow off of the cut dough pieces 18 to the conveying and transfer roll 80. The use of this configuration permits improved registration between the dough sheet 17 and the individual dough pieces 18 during blow off to the conveying and transfer roll 80. In this embodiment, the cutter roll 60 would be placed in the upper position. Cooling or heating of the cutter roll 60, like the previous explanation for cooling and heating of the anvil roll 40, is a contemplated embodiment of this invention.

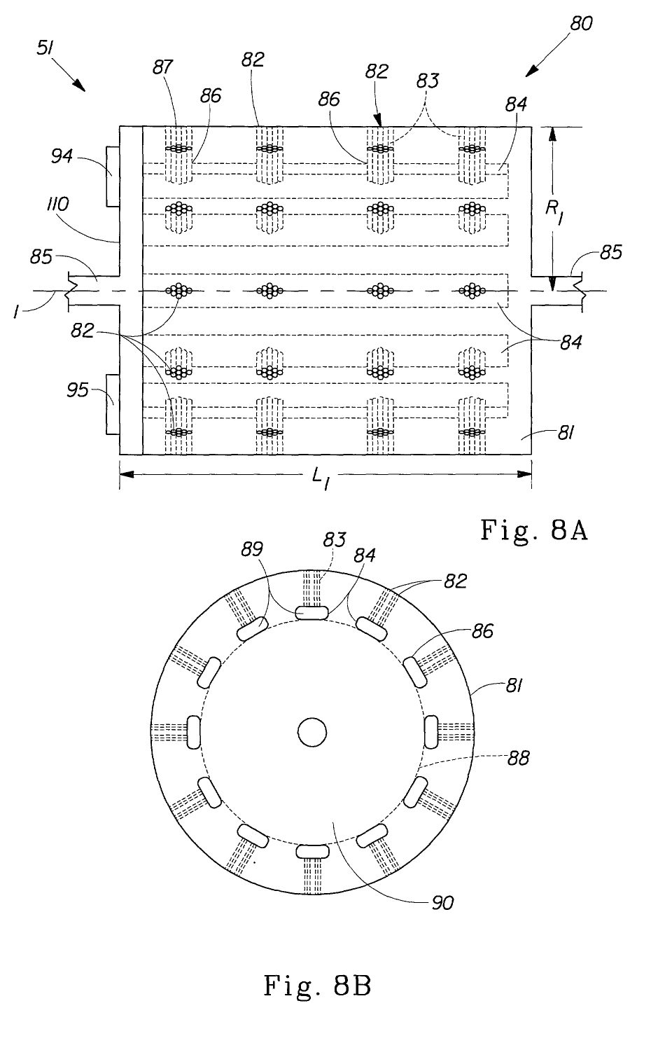

FIG. 8A depicts an exemplary embodiment of a transfer roll 80 as utilized in an exemplary in-line rotary cutting and conveying system 15 of the present invention. A transfer roll 80 might comprise a substantially cylindrical outer surface 81 and have a predetermined length L₁ and a predetermined radius R₁. Although length L₁ could be virtually any length, in an exemplary embodiment of the invention, length L₁ might be substantially equal to length L₂ of cutter roll 60. In this way, a transfer roll 80 and a cutter roll 60 might cooperate in transferring a plurality of individual dough portions 18, or a full row of individual dough portions, from a cutter roll 60 to a transfer roll 80.

It is contemplated that transfer roll 80 might be positioned adjacent to cutter roll 60, but not in contact with a cutter roll 60. In an exemplary embodiment of the invention, depending on the speed of the rolls, a cutter roll and a transfer roll might be separated by a distance d₂, or a distance of about 1 to 4 mm. Although transfer roll 80 can be constructed from virtually any hard material, in an exemplary embodiment, a transfer roll 80 might be constructed from hardened steel. It should be recognized from the foregoing that one of the advantages of the invention is providing a transfer roll in isolation from the other rolls of the system. In particular, a transfer roll 80 might be positioned closely adjacent a fryer, thereby subjecting the roll to the continuous heat of the fryer, which may result in thermal profiling or other deleterious effects of the roll. However, because the transfer roll is in isolation from the other rolls, heat from the transfer roll will not be transferred to any of the other rolls of the system. As a result, thermal profiling or the other deleterious effects of subsequent processing might not negatively affect either the anvil or cutter rolls.

In a non-limiting embodiment of the present invention, transfer roll 80 might comprise a transfer roll manifold system 51, similar to cutter roll manifold system 50 as described above. Once again, as will be explained in more detail, it is contemplated that a wide variety of structures and arrangements can be used to provide transfer roll manifold systems 51. For simplicity purposes, a single-zone transfer roll manifold system 51 comprising an internal transfer roll channel system 87 and an end cover assembly 110 will first be described and then a two-zone system and a four-zone system will be described as alternate embodiments of the invention.

FIGS. 8A and 8B depict a single-zone internal transfer roll channel system 87 that might be configured within a portion of a transfer roll 80 to provide selective pressure control to a plurality of airway apertures 82 located adjacent an outer surface 81 of transfer roll 80. In more detail, transfer roll 80 might be configured with a plurality of internal aperture channels 83 designed to provide pressure or underpressure/vacuum to airway apertures 82 positioned on outer surface 81 of transfer roll 80. In more detail, in a non-limiting embodiment of the invention, each internal aperture channel 83 might extend radially inward, or be positioned substantially perpendicular from outer surface 81 of transfer roll 80. One end of each internal aperture channel 83 might form an airway aperture 82 adjacent an outer surface 81. In this way, either underpressure or pressure can be provided to the airway apertures 82 positioned on outer surface 81 of transfer roll 80.

A second end 86 of an internal aperture channel 83 might be in airflow communication with a main airway channel 84. A main airway channel 84 might be positioned on an inner perimeter 88 of transfer roll 80 and might be positioned substantially parallel to an outer surface 81, and across nearly the entire length of a transfer roll 80 such that an end of channel 84 might terminate in an airway opening 89 provided in side wall 90 of transfer roll 80. In this way, selective pressure control can be provided at airway opening 89 such that pressure or underpressure might be provided through main airway channel 84 to a plurality of internal aperture channels 83 and be provided at airway apertures 82 of transfer roll 80.

In an exemplary embodiment of the invention, it is contemplated that a transfer roll 80 might comprise about 14 main airway channels 84 positioned around an inner perimeter 88 of a transfer roll 80. It should be recognized that the number of inner main airway channels 84 can vary and that the number of main airway channels 84 present in a transfer roll 80 might correspond with the number of number of main airflow channels 73 of corresponding cutter roll 60. Accordingly, the number of airway apertures 82 positioned on an outer surface of an transfer roll 80 might correspond with the number of airflow apertures 69 positioned on an outer surface of a cutter roll 60.

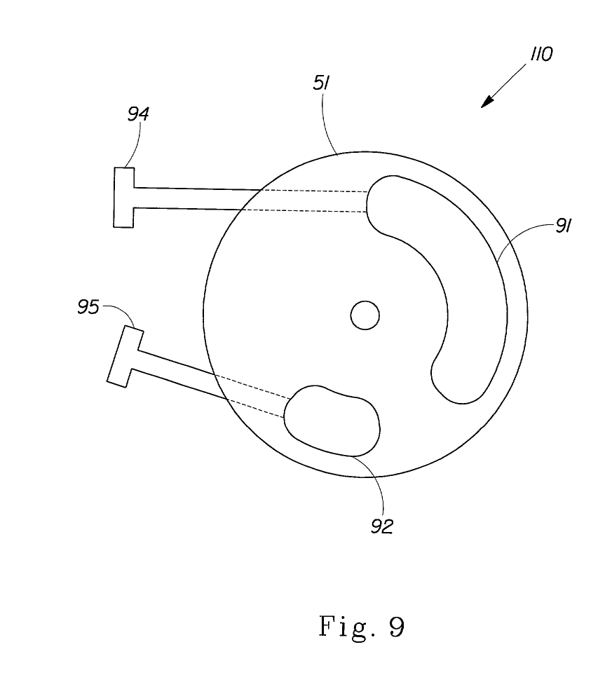

FIG. 9 illustrates an exemplary manifold system end cover assembly 110 configured to provide airflow through an internal transfer roll channel system 87. An end cover assembly 110 of transfer roll manifold system 51 might distribute vacuumed or pressurized air to a plurality of airway openings 89 positioned around an inner perimeter 88 of transfer roll 80.

In an exemplary embodiment of the invention, an end cover assembly 110 of a transfer roll manifold system 51 might be held in a stationary position while a transfer roll 80 rotates thereabout. A plastic covering, such as Rulon, might be provided on either the end cover assembly 110 or the transfer roll 80 to insulate and/or provide a seal between transfer roll 80 and stationary end cover assembly 110. In any event, like a cutter roll end cap assembly, a transfer roll manifold end cover assembly 110 might be configured with air cylinders (not depicted) that are configured to contact an outer portion of the assembly and compress the manifold end cover assembly 110 against transfer roll 80 for providing an air-tight seal between end cover assembly 100 and transfer roll 80. Once again, it should be recognized that there are a variety of mechanical configurations known in the art that might allow a stationary object, such as an end cover assembly 110 to contact a rotating object such as a transfer roll 80 and provide an air-tight seal.

In more detail, an air-tight seal provided between end cover assembly 110 and transfer roll 80 might allow end cover assembly 110 to distribute airflow throughout an internal transfer roll channel system 87. Specifically, an end cover assembly 110 might be configured with a plurality of airway cavities 91 and 92 formed along an interior surface 93 of end cover assembly 110. End cover assembly 110 might further comprise a plurality of airway connectors 94 and 95 capable of being connected to either a vacuum or a pressure source for providing pressure control throughout an end cover assembly 110. In an exemplary embodiment of the invention, an airway connector 94 might be configured to be connected to a vacuum pump for providing vacuuming suction at an airway cavity 91 of an end cover assembly and an airway connector 95 might be configured to be connected to a pressure pump for providing pressurized air flow at an airway cavity 92 of an end cover assembly 110. It should be recognized that the configuration of cavities could vary depending on design choice and that an end cover assembly is not limited to two cavities but could comprise any number of cavities including only one. For example, in one embodiment, an airway cavity might comprise an additional cavity for the purpose of internal roll cleaning. An additional cavity might be configured with pressure so that after a dough portion 18 is blown off a transfer roll, an additional burst of air might ensure each of the plurality of apertures 82 is free and clear from and remaining dough or debris. Additionally, it should be recognized that the cavities do not have to provide airflow, rather in some embodiment, the cavities might not be provided with either vacuum or pressure.

In a non-limiting embodiment of the invention, transfer roll 80 might rotate against a stationary end cap assembly such that airway opening 89 positioned on an inner side wall 90 of transfer roll 80 might align with airway cavities 91 and 92 of the stationary end cover assembly. In an exemplary embodiment, transfer roll 80 might rotate in a counter clockwise direction such that airway opening 89 might first align with airway cavity 91. Transfer roll 80 might continue to rotate such that airway opening 89 then aligns with airway cavity 92. Thus, each airway opening 89 positioned on inner side wall 90 of a transfer roll 80 might first be provided with a vacuum as airway opening 89 aligns with airway cavity 91 and then provided with pressure as airway opening 89 aligns with airway cavity 92.

From the foregoing, it should be recognized that, in operation, a transfer roll 80 might rotate at a substantially similar speed as that of a cutter roll 60, and might be coordinated, through gearing or otherwise, with a cutter roll 60 to provide for a transfer of a plurality of dough portions 18 from a cutter roll 60 to a transfer roll 80. In particular, to facilitate a transfer of dough portions 18, a cutter roll 60 might blow off or eject a plurality of dough portions 18, or a row of individual dough portions, at a desired location. Simultaneously, airway opening 89 of a rotating transfer roll 80 might align with airway cavity 91 of an end cover assembly 110 thereby causing a plurality of airway apertures 82, or a row of apertures, to be provided with vacuum suction. The vacuum suction of transfer roll 80 might essentially “catch” the blown off dough portions 18 and suction them against an outer surface 81 of transfer roll 80. In other words, a plurality of dough portions 18, or a row of dough portions, might be transferred from a cutter roll 60 to a transfer roll 80. Vacuum suction might continue to hold a plurality of dough portions 18 against an outer surface 81 of transfer roll 80 until airway opening 89 of transfer roll 80 aligns with airway cavity 92 of end cover assembly 110. Airway cavity 92 might be provided with pressurized air such that the pressurized air might blow a plurality of dough portions 18 off an outer surface of transfer roll 80. It should also be recognized that while being firmly received on an outer surface of a transfer roll, it is contemplated that a system 15 might further comprise other shape forming or printing machines configured to interact with each individual portion of material prior to being transferred from the roll.

Once again, it should be recognized that an end cover assembly 110 might also be capable of being manually adjusted relative to a transfer roll 80. In particular, prior to operation of a system 15, an end cover assembly 110 might be configured to be rotated to change the positioning of airway cavities 91 and 92. For example, if an operator desired to change the positioning of an area at which a transfer roll 60 blows off a plurality of dough portions 18, an end cover assembly 110 might be rotated prior to operation of a system 15. In a non-limiting embodiment of the invention, end cover assembly 110 might be configured to be manually adjustable to about 5 different positions to accommodate for different desired settings of a system 15.

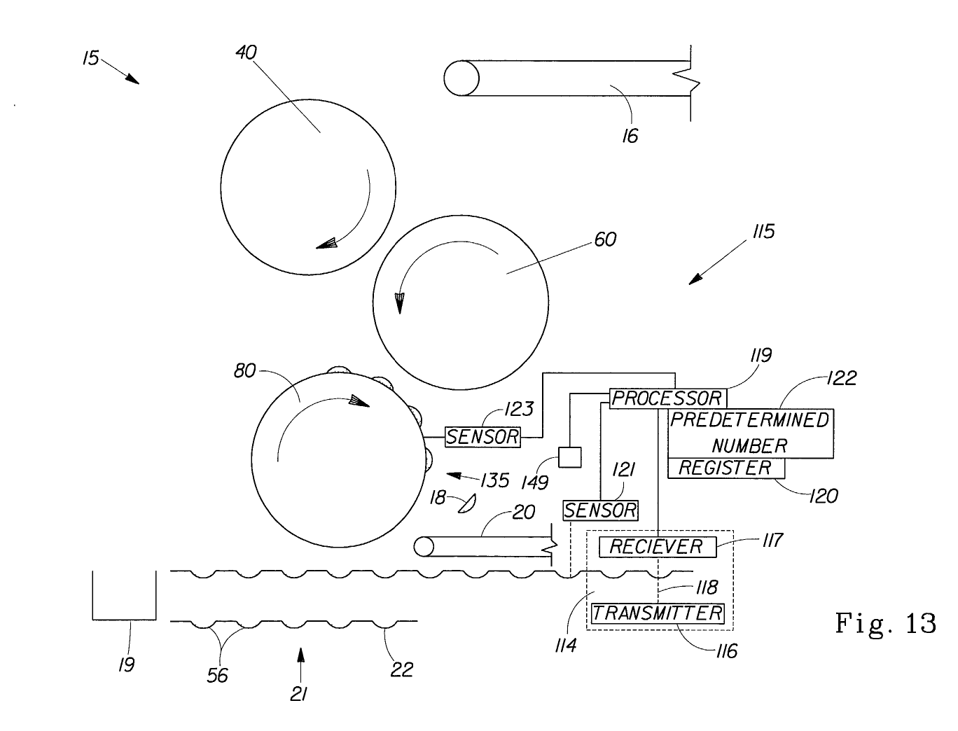

Separately, and as best illustrated in FIG. 13, it should be recognized that a carrier system 21 might comprise an effectively or substantially continuous loop of a plurality of carrier zones or pockets 22 configured to convey a plurality of dough portions 18 to a fryer 19 from a transfer roll 80. It should be recognized that a pocket 22 might be any configuration or shape or might even be a designated area, such as an area on a flat conveyor belt. In an exemplary embodiment of the invention, a carrier zone or pocket 22 might comprise a saddle shape. A carrier system 21 might be configured with a motor (not shown) separate from that provided to drive a transfer roll 80. It should be recognized that for transfer roll 80 to transfer a plurality of dough portions 18 to carrier system 21, a motor driving transfer roll 80 might be indexed with that of a carrier system to allow a dough portion 18 blown off transfer roll 80 to be received by a carrier zone 22 of a carrier system 21. As used herein, the term “indexed” is contemplated to mean that the timing of transfer of a dough portion between a transfer roll, or other roll to a carrier zone of a carrier system is coordinated. To achieve proper indexing, a sensor 121 such as an encoder might be positioned on a carrier system 21 and a second encoder 123 might be positioned on a transfer roll 80. Each encoder might be in communication with a processor 119 that might be configured to calculate a timing difference between the rotational movement of a transfer roll 80 and a conveying movement of a carrier system 21. A processor 119 might be in communication with a servo motor 27 and configured to adjust the speed of a transfer roll 80 to ensure proper timing or indexing between a transfer roll 80 and a carrier system 21.

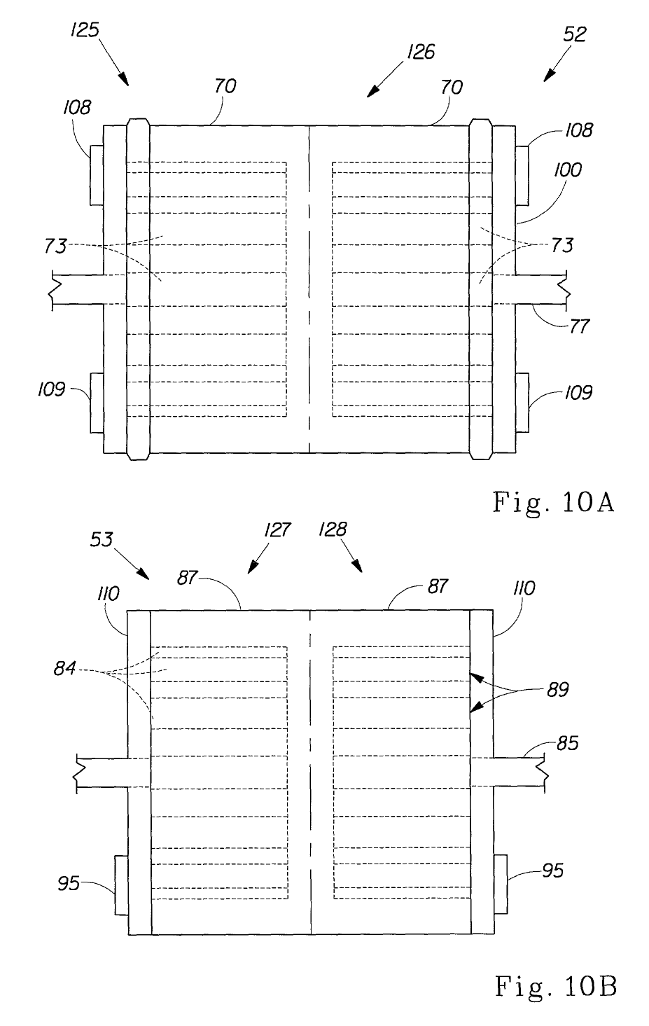

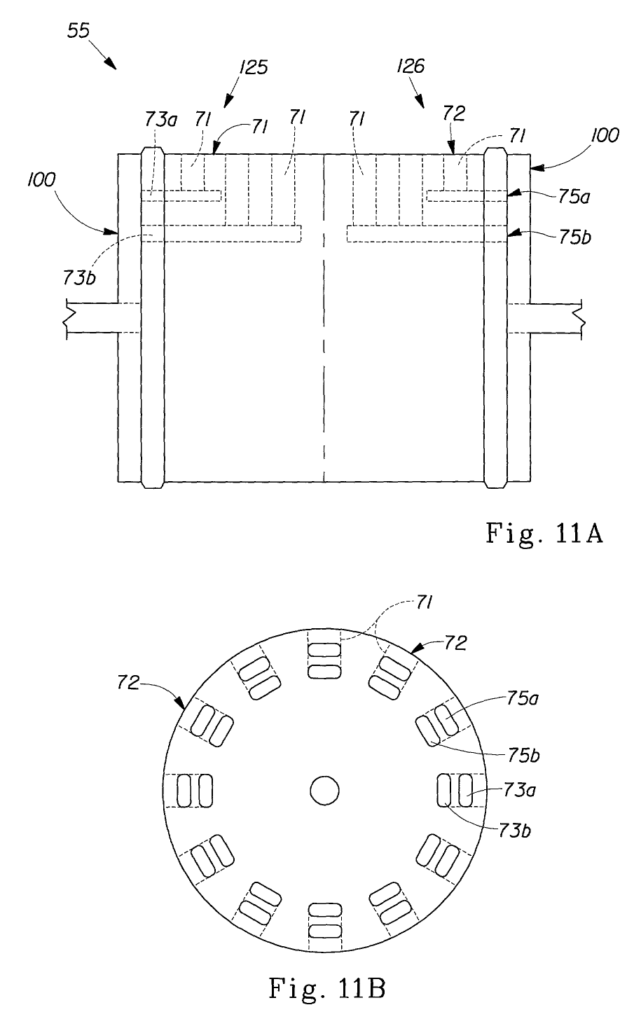

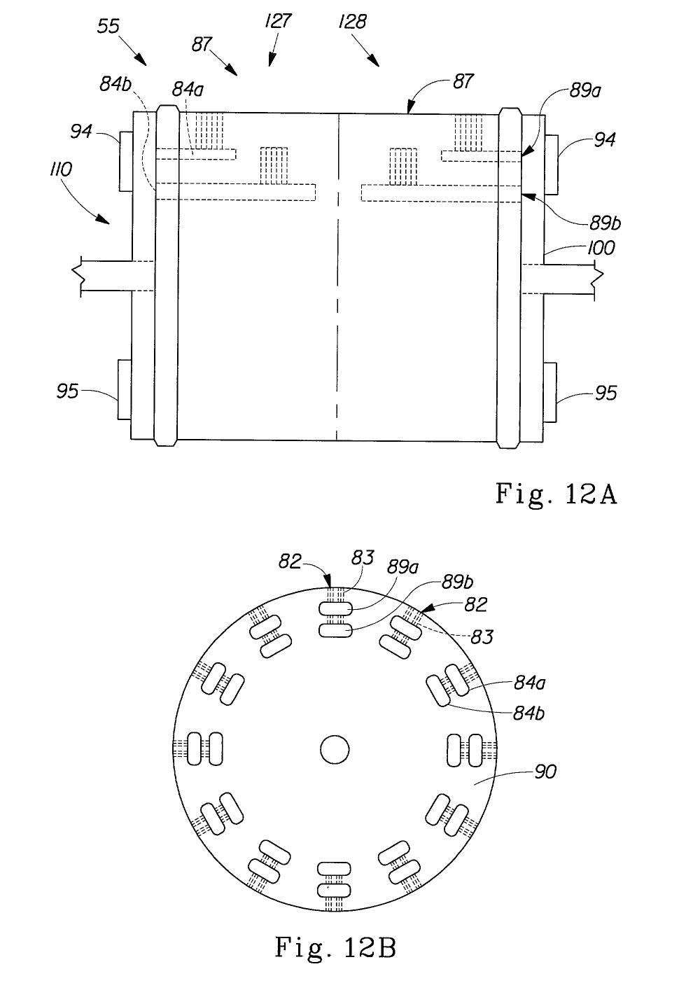

FIGS. 10A, 10B, 11A, 11B, 12A and 12B depict alternate exemplary embodiments of an in-line rotary cutting and conveying system 15. In particular, FIG. 10A depicts an exemplary two-zone cutter roll manifold system 52 and FIG. 10B depicts an exemplary two-zone transfer roll manifold system 53. FIGS. 11A and 11B depict an exemplary four-zone cutter roll manifold system 54 and FIGS. 12A and 12B depict an exemplary four-zone transfer roll manifold system 55. It should be recognized that both a two-zone and a four-zone cutter roll and transfer roll manifold system comprise only a slight constructional changes from a single-zone cutter roll 50 and a single-zone transfer roll manifold system 51 as previously described. Additionally, it should be noted that the advantages of providing either a two-zone system or a four zone system will be subsequently discussed.

FIG. 10A depicts an exemplary two-zone cutter roll manifold system 52 that might comprise an internal channel system 70 and an end cap assembly 100. A two-zone cutter roll manifold system 52 might comprise two mirror-image or identical halves: a left half 125 and a right half 126. It should be recognized that a left half 125 of a two-zone cutter roll manifold system 52 might be substantially identical to a single-zone manifold system 50 as previously described, with the only difference being that a main airflow channel 73 might terminate at about a half-way point of a two-zone system. Thus, a two-zone cutter roll manifold system 52 might comprise a left portion 125 that is substantially identical to a single-zone manifold system 50 and a right portion 126 that is a mirror image of a left portion 125.

FIG. 10B depicts an exemplary two-zone transfer roll manifold system 53 that might comprise an internal transfer roll channel system 87 and an end cover assembly 110. A two-zone transfer roll manifold system 53 might also comprise two mirror-image or identical halves: a left half 127 and a right half 128. It should be recognized that a left half 127 of a two-zone transfer roll manifold system 53 might be substantially identical to a single zone system 51 as previously described, with the only difference, once again, being that a main airway channel 84 might terminate at about a half-way point of a two-zone system. Thus, a two-zone transfer roll manifold system 53 might comprise a left portion 127 that is substantially identical to a single-zone manifold system 51 previously described and a right portion 128 that is a mirror image of a left portion 127.

FIG. 11A depicts an exemplary four-zone cutter manifold system 54 comprising an internal channel system 70 and an end cap assembly 100. Once again, it should be recognized that a four-zone cutter manifold system 52 might comprise two mirror-image or identical halves: a left half 125 and a right half 126. However, in this embodiment, a four-zone manifold system might comprise two main airflow channels 73a and 73b each positioned substantially parallel to an outer surface 61 of a cutter roll 60. A first main airflow channel 73a might have one end that terminates in airflow opening 75a provided in a side wall 74 of cutter roll 60 and a second end that might terminate about one-quarter of the length of cutter roll 60. A second main airflow channel 73b might have one end that terminates in a second airflow opening 75b provided in a side wall 74 of cutter roll 60 and a second end that might terminate about a half-way point of cutter roll 60. In addition, it is contemplated that a second main airflow channel 73b might be provided directly beneath a first main airflow channel 73a as depicted in FIG. 11B. It should be recognized that each of the main airflow channels 73 might provide airflow to a plurality of airflow apertures 69 positioned in an outer surface 61 of cutter roll 60. For example, a first main airflow channel 73a might be in airflow communication with a plurality of internal orifice channels 71 such as those positioned within about one-quarter of the length of cutter roll 60 and a second main airflow channel 73b might be in airflow communication with a plurality of internal orifice channels 71 such as those positioned within between about one-quarter of the length of cutter roll 60 and about one-half the length of cutter roll 60. Lastly, it should be recognized that airflow openings 75a and 75b associated with the two main airflow channels 73a and 73b might both be configured to be in airflow communication with airflow cavities 102 and 103 of an end cap assembly 100.

FIG. 12A depicts an exemplary four-zone transfer roll manifold system 55 comprising an internal transfer roll channel system 87 and an end cover assembly 110. Once again, a four-zone transfer roll manifold system 55 might comprise two mirror-image or identical halves: a left half 127 and a right half 128. However, in this embodiment, a four-zone manifold system might comprise two main airway channels 84a and 84b each positioned substantially parallel to an outer surface 81 of transfer roll 80. A first main airway channel 84a might have one end that terminates in an airway opening 89a provided in a side wall 90 of transfer roll 80 and a second end that might terminate about one-quarter of the length of transfer roll 80. A second main airflow channel 84b might have one end that terminates in a second airway opening 89b provided in a side wall 90 of transfer roll 80 and a second end that might terminate about the half-way point of transfer roll 80. In addition, it is contemplated that a second main airway channel 84b might be provided directly beneath a first main airway 84a channel as depicted in FIG. 12B. It should be recognized that each of the main airway channels 84a and 84b might provide airflow to a plurality of airway apertures 82 positioned on an outer surface 81 of a transfer roll 80. For example, a first main airway channel 84a might be in air flow communication with a plurality of internal aperture channels 83a such as those positioned within about one-quarter of the length of a transfer roll and a second main airway channel 84b might be in airflow communication with a plurality of internal aperture channels 83b such as those positioned within between about one-quarter of the length of a transfer roll and about one-half the length of a transfer roll 80. Lastly, it should be recognized that airway openings 89a and 89b associated with the two main airway channels 84a and 84b might both be configured to be in airflow communication with airway cavities 91 and 92 of an end cover assembly 110.

FIG. 13 diagrammatically illustrates another embodiment of the invention, wherein an in-line cutting and conveying system 15 might further comprise a pocket-blockage detection system 115. A pocket-blockage detection system might be designed to prevent damage to a carrier system 21 or to any other component of a pocket-blockage detection system 115 by detecting whether a pocket 22 is clear and available or whether a pocket might comprise a stuck as a dough chip 56. As used herein, the term “dough chip” is contemplated to mean a dough portion 18 that has been sent to the fryer and has by fried into a chip 56. A pocket blockage detection system 115 might also prevent waste, contamination via over fried dough, and might minimize unacceptable finished products. If a system 115 detects a pocket blockage, the system might prevent a new dough portion 18 from being placed on top of a stuck chip 56 in a blocked pocket 22.

In general, a carrier system 21 might comprise a continuous loop of a plurality of pockets 22 configured to convey a plurality of dough portions 18 to a fryer 19. Each of a plurality of pockets or zones 22 might receive a dough portion 18 from a transfer roll 80 and convey the dough portions 18 to a fryer where the dough portions might be fried to a crisp chip 56 and removed from the pocket. Upon exiting a fryer 19, a pocket 22 might move in a continuous loop toward a transfer roll 80 for the purpose of conveying another dough portion 18 to a fryer 19. It should be recognized from the foregoing that, for optimal performance, a pocket 22 might need to be free from dough chips 56 or other debris before receiving a new dough portion 18 from a transfer roll 80 for the purpose of preventing damage to a pocket 22 or any other component of a system 15. Thus, if a pocket 22 comprises a stuck chip 56, a transfer roll 80 might be configured to not transfer a dough portion 18 to a pocket 22.

It should be recognized that to facilitate a non-transfer of a dough portion 18 from a transfer roll 80 to a pocket 22 of a carrier system 21, a system 15 might be configured with an early “eject” system 135. In an exemplary embodiment of the invention, an eject system 135 might cause a transfer roll 80 to “eject” or blow off a dough portion 18 prior to a transfer roll 80 reaching an area where a transfer roll 80 would otherwise transfer that dough portion 18 to a carrier zone or pocket 22. As will be explained in more detail, a slight constructional modification to an end cover assembly 110 of a transfer roll 80 might facilitate ejection or blowing off a dough portion 18 prior to a transfer roll 80 reaching an area where a transfer roll 80 might transfer a dough portion 18 to a pocket 22.

Continuing with FIG. 13, a pocket-blockage detection system 115 might comprise a monitoring station 114 located along side a carrier system. A monitoring station might comprise a plurality of sensors such as a light source transmitter 116 in communication with a light source receiver 117. In more detail, a light source transmitter 116 might be positioned underneath or along side, and a light source receiver 117 might be positioned above or along an opposite side of a carrier system 21 having a plurality of pockets 22. A transmitter 116 might transmit a light source 118 to a receiver 117 such that a pocket 22 might pass through the light source 118 on its way to receiving a cut dough portion 18 from a transfer roll 80.

It is contemplated that a pocket 22 might comprise a plurality of holes configured to allow a light source to pass through to a receiver 117 without substantial interruption. If a pocket 22 comprises a stuck chip 56, or other debris, a light source might be substantially interrupted from transmission to a receiver 117. Upon being interrupted, a receiver 117 in communication with a processor 119 might transmit a signal to a processor to “eject” or blow off a dough portion 18 that might otherwise be transferred from a transfer roll 80 to a pocket 22 having a stuck chip.

Recognizing that a dough portion 18 on a transfer roll 80 might need to be “ejected” or blown off a transfer roll prior to a point or area where a transfer roll 80 might transfer a dough portion to a pocket 22, a processor 119 might be configured with instructions such as a program, algorithm, or the like that allows a system 15 to eject at least one dough portion from a transfer roll. In more detail, it is contemplated that a processor might be configured with a predetermined number 122 that represents a number of positions a transfer roll 80 might have to rotate before having to “eject” a corresponding dough portion. A system 115 might also be configured with a sensor 121 such as an encoder, in communication with a processor 119, which might track, or “count” each pocket 22 that passes by a sensor 121. A sensor 121 might transmit a count back to a processor 119, where the count might be stored in a register 120. Once a count stored in a register 120 equals a predetermined number 122 also stored in a processor 119, a processor might send a signal to a system 15 to eject or blow off a dough portion 18 from a transfer roll 80. In this way, when the transfer roll 80 reaches a point or area where dough portions might be transferred to a pocket, a transfer roll 80 might not have dough portions held against an outer surface 81 to transfer. Thus, a dough portion 18 may have been prevented from being placed on top of a pocket 22 comprising a stuck chip 56.

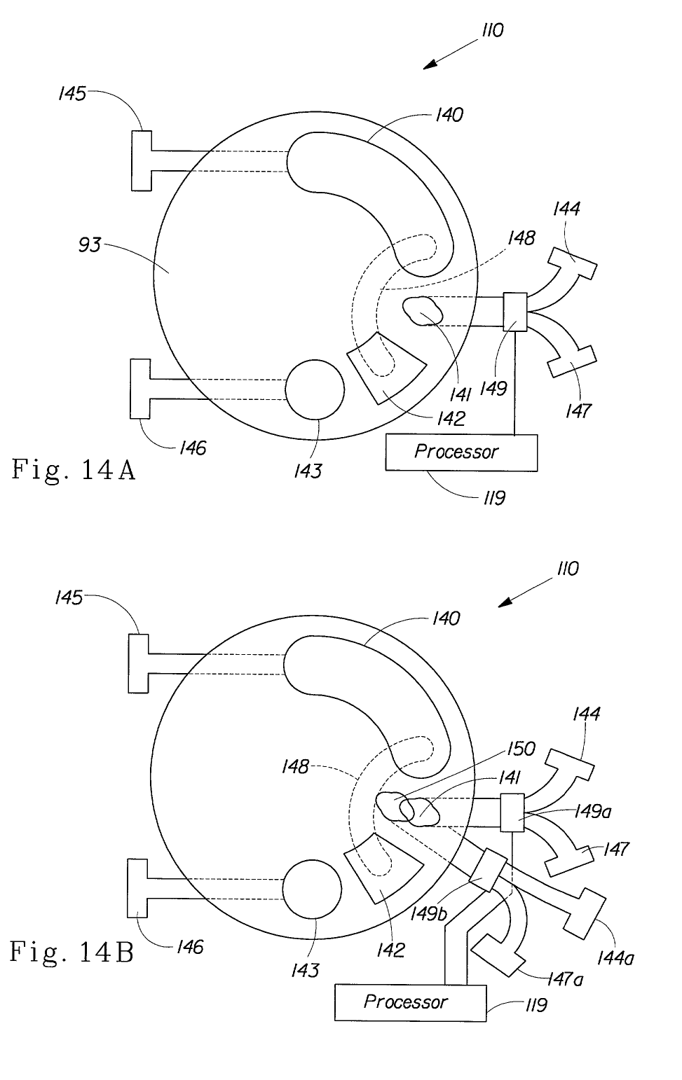

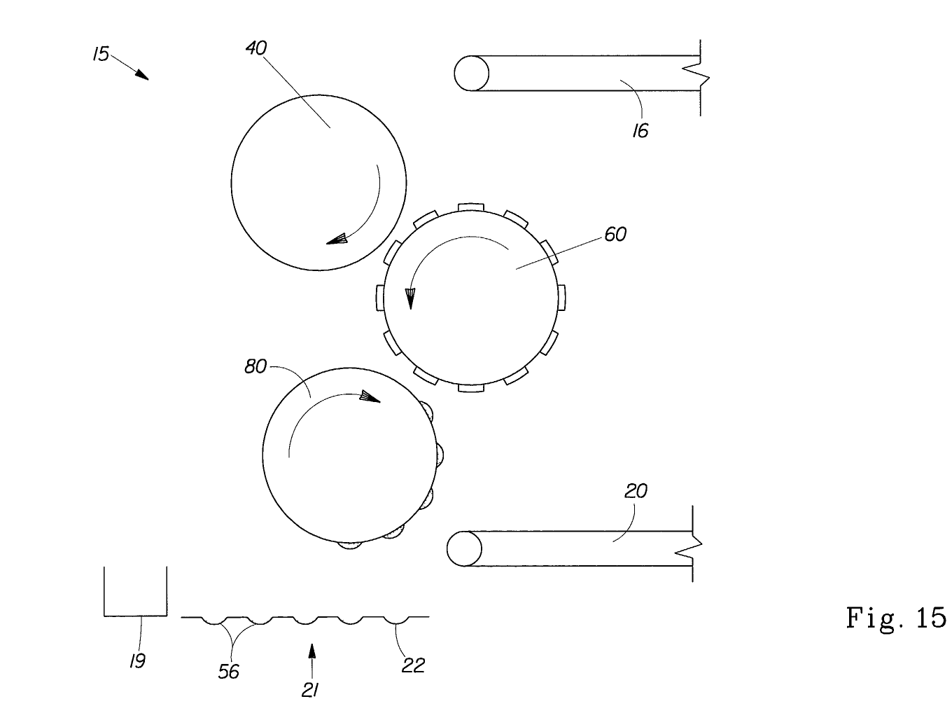

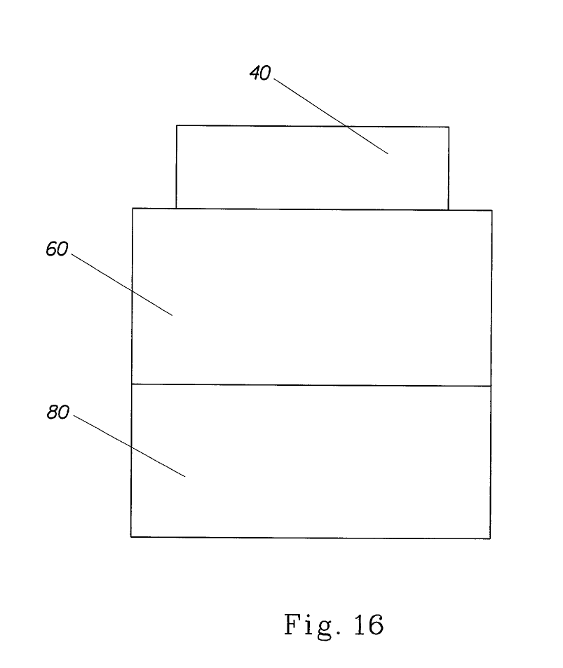

FIGS. 14A and 14B depict an exemplary end cover assembly 110 as might be constructed to facilitate a non-transfer of a dough portion 18 from a transfer roll 80 to a pocket 22. In other words, an exemplary end cover assembly might be configured to blow off at least one dough portion 18 prior to an area where a transfer roll 80 might transfer a dough portion 18 to a pocket 22.

FIG. 14A depicts an exemplary end cover assembly 110 configured for use with either a single-zone 51 or two-zone transfer roll manifold system 53. In particular, an end cover assembly 110 might be configured with a plurality of cavities 140, 141, 142 and 143 formed along an interior surface 93 of an assembly 110. An end cover assembly 110 might further comprise a plurality of airway connectors 144, 145, 146 and 147 capable of being connected to either a vacuum or a pressure source for providing vacuum or pressure throughout an end cover assembly 110. In an exemplary embodiment of the invention, airway connector 145 might be configured to be connected to a vacuum pump for providing vacuuming suction at cavities 140 and 142 of end cover assembly. It should be recognized that an internal connecting pipe 148 might provide airflow communication between these cavities or that other alternative methods are also feasible. Airway connector 146 might be configured to be connected to a pressure source for providing pressure at cavity 143 of end cover assembly 110.

In an exemplary embodiment of the invention, a cavity 141 might be in communication with airway connectors 144 and 147. Airway connector 144 might be configured to be connected to a vacuum for providing vacuuming suction and airway connector 147 might be configured to be connected to a pressure source for providing pressure. Thus, airway cavity 141 might be configured to provide either vacuum or pressure. A valve 149, in communication with a processor 119, might be configured to allow either vacuum or pressure to be provided to cavity 141.

In operation, it should be recognized that as a transfer roll 80 rotates against an end cover assembly 110, airway opening 89 might align with cavities 140, 141, 142 and 143. A cavity 140 might provide vacuuming suction, which might hold dough portions 18, or a row of dough portions, against a transfer roll 80. Upon rotating to a position where airway opening 89 aligns with cavity 141, a processor 119, as described above, might determine whether a row of dough portions 18 should be ejected from the transfer roll 80. If a row of dough portions 18 are to be ejected because a pocket 22 comprises a stuck chip 56, a processor 119 might communicate to a valve 149 to provide pressure to cavity 141 to blow the dough portions 18 from transfer roll 80. In contrast, if a row of dough portions 18 are not to be “ejected” vacuum suction is provided at cavity 141. A roll 80 is provided with vacuum suction until the roll aligns with cavity 143, where pressure might be provided to blow the row of dough portions from transfer roll 80 and into a row of corresponding pockets or carrier zones 22.

FIG. 14B depicts an exemplary end cover assembly 110 configured for use with a four-zone transfer roll manifold system 53. This embodiment is substantially similar to the previously described single-zone or two-zone transfer roll manifold systems, with the exception that a four-zone manifold system might comprise an additional cavity 150. A cavity 150 might also be in communication with air flow connectors 144 and 147, which might be configured to provide vacuum suction or pressure, respectively. Thus, cavity 41 and cavity 150, of a four-zone system, might be configured to provide either vacuum or pressure. A plurality of valves 149a and 149b, in communication with a processor 119, might be configured to allow either underpressure, such as a vacuum or pressure to be provided to cavity 141 and/or cavity 150.

In operation, it should be recognized that as a transfer roll 80 might rotate against an end cover assembly 110, such that a plurality of airway openings 89a and 89b might align with cavities 140, 141, 142, 143 and 150. Similar to a two-zone system, cavity 140 might provide vacuum suction, which might help hold a plurality of dough portions 18 against a transfer roll 80. Upon rotating to a position where one airway opening 89a aligns with cavity 141 and the other airway opening 89b aligns with cavity 150, a processor 119, as described above, might determine whether a plurality of dough portions 18 should be ejected from transfer roll 80. If the dough portions 18 are to be ejected because a pocket 22 comprises a stuck chip 56, a processor 119 might communicate to a valve 149a and/or 149b to provide pressure to cavities 141 and/or 150 to blow the respective dough portions 18 from a transfer roll 80. In contrast, if the dough portions 18 are not ejected, vacuum suction is provided at cavities 141 and 150. A roll 80 might be provided with vacuum suction or underpressure until the roll aligns with cavity 143, where pressurized air might be provided to blow the dough portions from a transfer roll 80 and into a pocket 22.

In an in-line cutting and conveying system 15 utilizing a single-zone manifold system 51, it should be recognized that because a main airway channel 84 might be positioned substantially parallel to an outer surface 81, and across nearly the entire length of transfer roll 80, a decision to eject a dough portion 18 would normally result in every dough portion 18 in communication with a main airway to be ejected, or an entire row or dough portions. In more detail, as previously described, a main airway channel 84 might terminate in airway opening 89 which might align with cavity 141 configured to provide either vacuum suction or pressure. If any pocket 22 comprises a stuck dough chip 56, pressure might be provided at cavity 141 to “eject” or blow off an entire row of dough portions 18 to potentially prevent damage to a system 15. Thus, utilization of single-zone transfer roll system might lead to excessive waste and ineffectiveness of a system 15 as every dough portion in communication a main airway channel 84 might be ejected prior to transfer. While ejected dough portions 18 could be reclaimed for recycle or reprocessing, there would still be potential waste of resources.

It should be recognized from the foregoing that utilization of multi-zone (e.g. two-zone or four-zone) manifold system might improve efficiency and reduce waste. For example, a two-zone. system might comprise two main airway channels 84, one located at each end of a transfer roll 80, such that each airway channel might provide vacuum or pressure to about one half of length of a transfer roll 80. Thus, providing pressure to eject a dough portion 18 in this embodiment, would result in only the dough portions 18 positioned on any one half of a length of transfer roll 80 being ejected. Similarly, a four-zone system might comprise four main airway channels 84, two positioned on one side of a transfer roll and two positioned on another side of transfer roll 80 such that each main airway channel 84 might provide vacuum or pressure to about one quarter of a length of transfer roll 80. In such an application, providing pressure to eject a dough portion 18 would result in only the dough portions 18 positioned on any one quarter of a length of transfer roll 80 being ejected.

It should also be recognized that a pocket-blockage detection system 115 could also be configured in a substantially similar manner on a cutter roll 60. In this embodiment, a cutter roll might “eject” or blow off a plurality of dough portions prior to an area where a cutter roll 60 might transfer the plurality of dough portions to a transfer roll 80. Similar to a transfer roll 80 configuration, a cutter roll comprising a pocket-blockage detection sensing system 115 might be configured with a single-zone, two-zone or four-zone manifold system.

Separately, it is contemplated that separate or multiple take away conveying systems 20 might be constructed to convey ejected dough portions or the unused portion of a sheet 17 of material back to a recycle bin (not shown). It should be noted that noted that providing a stuck chip sensing system 115 and a ejection system 135 on a cutter roll 60 might provide additional advantages to an in-line cutting and conveying system 15. For example, separate take away conveying systems might be required to convey the ejected dough portions 18 and the unused portion of a sheet 17 of material to a recycle bin. The speeds of these conveying might be capable of being optimized since they are conveying separate materials.

Having shown and described the preferred embodiments of the present invention, further adaptations of the in-line rotary cutting and conveying system of the present invention as described herein can be accomplished by appropriate modifications by one of ordinary skill in the art without departing from the scope of the present invention. Several of these potential modifications and alternatives have been mentioned, and others will be apparent to those skilled in the art. For example, while exemplary embodiments of the system have been discussed for illustrative purposes, it should be understood that the elements described will be constantly updated and improved by technological advances. Accordingly, the scope of the present invention should be considered in terms of the following claims and is understood not to be limited to the details of structure, operation or process steps as shown and described in the specification and drawings.

We claim:

1. An in-line cutting and conveying system for cutting and processing a plurality of individual product portions from a sheet of material, said system comprising:
a cutter roll positioned in an upper position having an outer surface configured to receive and support a sheet of material;
an anvil roll positioned in a center positioned and adjacent to the cutter roll, the cutter roll comprising a plurality of spaced cutter cells each configured to interface with the cutter roll in use to cut and receive an individual product portion of the material positioned on said outer surface of the anvil roll; and
a transfer roll positioned adjacent to the anvil roll, the transfer roll positioned and configured to receive individual product portions of material from the anvil roll.
